(19) United States
(12) Patent Application Publication
(10) Pub. No.: US 2007/0156330 A1
(43) Pub. Date: Jul. 5, 2007

(54) Point-to-point shortest path algorithm

(75) Inventors: Andrew Goldberg, Redwood City, CA (US); Haim Kaplan, Hod Hasharon (IL); Renato Werneck, Princeton, NJ (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/321,349

(22) Filed: Dec. 29, 2005

(51) Int. Cl. G01C 21/34

(52) U.S. Cl. 701/202; 701/209

(57) ABSTRACT

A graph is selected for preprocessing. Partial shortest path trees are constructed for the vertices of the graph and shortcuts are added to the graph to reduce the reach of certain vertices. The partial trees can be used to divide the arcs into two groups, a high reach group and a low reach group wherein a reach threshold is used to divide the groups. This threshold may be a function of the number of iterations of the preprocessing algorithm performed thus far. Upper bounds on reach of the low reach arcs are computed, and these arcs are deleted from the graph. The preprocessing algorithm is applied iteratively to the remaining arcs in the graph, with the reach threshold changing based on the current iteration. At the end of the preprocessing phase all arc reaches are below the current threshold and are deleted. The graph obtained from the input graph by adding the shortcuts, together with the reach values, may then be used during a query phase to compute shortest paths between two vertices.

### CROSS-REFERENCE TO RELATED APPLICATIONS

This application is related to U.S. patent application Ser. No. 10/925,751, filed Aug. 25, 2004 and U.S. patent application Ser. No. 11/115,558, filed Apr. 27, 2005. Both applications are incorporated by reference in their entirety.

### BACKGROUND

Existing computer programs known as “road-mapping” programs provide digital maps, often complete with detailed road networks down to the city-street level. Typically, a user can input a location and the road-mapping program will display an on-screen map of the selected location. Several existing road-mapping products typically include the ability to calculate a “best route” between two locations. In other words, the user can input two locations, and the road-mapping program will compute the travel directions from the source location to the destination location. The directions are typically based on distance, travel time, and certain user preferences, such as a speed at which the user likes to drive, or the degree of scenery along the route. Computing the best route between locations may require significant computational time and resources.

Existing road-mapping programs employ variants of a method attributed to E. Dijkstra to compute shortest paths. Dijkstra's method is described by Cormen, Leiserson and Rivest in Introduction to Algorithms, MIT Press, 1990, pp. 514-531, which is hereby incorporated by reference in its entirety for all that it teaches without exclusion of any part thereof. Note that in this sense “shortest” means “least cost” because each road segment is assigned a cost or weight not necessarily directly related to the road segment's length. By varying the way the cost is calculated for each road, shortest paths can be generated for the quickest, shortest, or preferred routes.

Dijkstra's original method, however, is not always efficient in practice, due to the large number of locations and possible paths that are scanned. Instead, many modern road-mapping programs use heuristic variations of Dijkstra's method, including A* search (a.k.a. heuristic or goal-directed search) in order to “guide” the shortest-path computation in the right general direction. Such heuristic variations typically involve estimating the weights of paths between intermediate locations and the destination. A good estimate reduces the number of locations and road segments that must be considered by the road-mapping program, resulting in a faster computation of shortest paths; a bad estimate can have the opposite effect, and increase the overall time required to compute shortest paths. If the estimate is a lower-bound on distances with certain properties, A* search computes the optimal (shortest) path. The closer these lower-bounds are to the actual path weights, the better the estimation and the algorithm performance. Lower-bounds that are very close to the actual values being bound are said to be “good.” Previously known heuristic variations use lower-bound estimation techniques such as Euclidean distance (i.e., “as the crow flies”) between locations, which are not very good.

More recent developments in road mapping algorithms utilize a two-stage process comprising a preprocessing phase and a query phase. During the preprocessing phase the graph or map is subject to an off-line processing such that later real time queries between any two destinations on the graph can be made more efficiently. Previous examples of preprocessing algorithms use geometric information, hierarchical decomposition, and A* search combined with landmark distances.

In Reach-based Routing: A New Approach to Shortest Path Algorithms Optimized for Road Networks In Proc. 6th International Workshop on Algorithm Engineering and Experiments, pages 100-111, 2004, Gutman introduced the notion of vertex reach and showed how it can be used to prune shortest path search. Search pruning is based on upper bounds on vertex reaches and lower bounds on vertex distances between the search origin and the search destination. Gutman uses Euclidean distances for lower bounds, and combines reach with A* search that uses Euclidean lower bounds. The above cited article is hereby incorporated by reference in its entirety for all that it teaches without exclusion of any part thereof.

While these methods have resulted in more efficient query phases, these methods are often not practical for very large graphs.

### SUMMARY

A graph is selected for preprocessing. Partial shortest path trees are constructed for the vertices of the graph and shortcuts are added to the graph to reduce the reach of certain vertices. The partial trees can be used to divide the arcs into two groups, a high reach group and a low reach group wherein a reach threshold is used to divide the groups. This threshold may be a function of the number of iterations of the preprocessing algorithm performed thus far. Upper bounds on reach of the low reach arcs are computed, and these arcs are deleted from the graph. The preprocessing algorithm is applied iteratively to the remaining arcs in the graph, with the reach threshold changing based on the current iteration. At the end of the preprocessing phase all arc reaches are below the current threshold and are deleted. The graph obtained from the input graph by adding the shortcuts, together with the reach values, may then be used during a query phase to compute shortest paths between two vertices.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a diagram illustrating an exemplary graph in accordance with the present invention;

FIG. 2 is a diagram illustrating the prefix and suffix of a path with respect to a vertex in accordance with the present invention;

FIG. 3 is a flow diagram illustrating an exemplary method for graph preprocessing in accordance with the present invention;

FIG. 4 is a diagram illustrating an exemplary graph in accordance with the present invention;

FIG. 5 is a diagram illustrating an exemplary graph with the addition of a shortcut arc in accordance with the present invention;

FIG. 6 is a diagram illustrating another exemplary graph with addition of shortcut arcs in accordance with the present invention;

FIG. 7 is a flow diagram illustrating an exemplary method for adding shortcut arcs to a graph in accordance with the present invention; and

FIG. 8 is a block diagram representing an exemplary non-limiting computing device in which the present invention may be implemented.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

The present invention will be more completely understood through the following detailed description, which should be read in conjunction with the attached drawings. In this description, like numbers refer to similar elements within various embodiments of the present invention. The invention is illustrated as being implemented in a suitable computing environment. Although not required, the invention will be described in the general context of computer-executable instructions, such as procedures, being executed by a personal computer. Generally, procedures include program modules, routines, functions, programs, objects, components, data structures, etc. that perform particular tasks or implement particular abstract data types. Moreover, those skilled in the art will appreciate that the invention may be practiced with other computer system configurations, including handheld devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices. The term computer system may be used to refer to a system of computers such as may be found in a distributed computing environment.

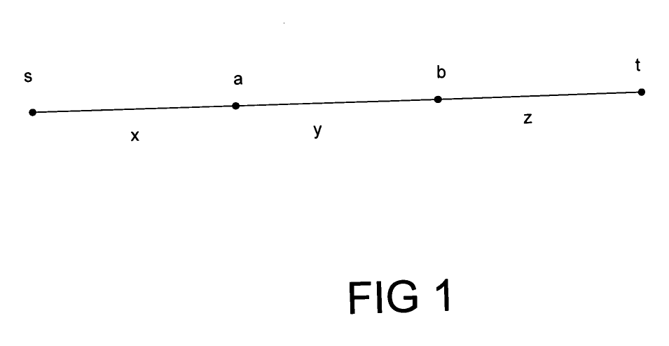

The point to point (“P2P”) algorithm is directed to finding the shortest distance between any two points in a graph. The graph may represent a road map, for example. However, there are many uses for the P2P algorithm, and it is not meant to limit the invention to maps. The P2P algorithm may comprise several stages including a preprocessing stage and a query stage. The preprocessing phase may take as an input a directed graph 100 as illustrated in FIG. 1. Such a graph may be represented by G=(V, E), where V represents the set of vertices in the graph and E represents the set of edges or arcs in the graph. As shown, the graph 100 comprises several vertices labeled s, a, b, and t, as well as several edges labeled x, y, and z. The preprocessing phase may be used to improve the efficiency of a later query stage, for example.

During the query phase, a user may wish to find the shortest path between two particular nodes. The origination node may be known as the source vertex, labeled s, and the destination node may be known as the sink vertex labeled t. For example, an application for the P2P algorithm may be to find the shortest distance between two locations on a road map. Each destination, or intersection on the map may be represented by one of the nodes, while the particular roads and highways may be represented by an edge. The user may then specify their starting point s and their destination t.

A prior art solution for determining a particular shortest path between s and t is known as Dijkstra's algorithm, which is an implementation of the labeling method. In the labeling method, the shortest paths are determined from a particular source s to all vertices. The algorithm maintains for each vertex its distance label d, its parent vertex p, and a status indicator for that vertex, such as unreached, labeled, or scanned. Initially, for each vertex d is set to infinity, p is set to nil, and status is set to unreached. For the source vertex s, d is set to zero, p to nil, and s to labeled. While there are labeled vertices, the algorithm picks a vertex v, relaxes all arcs out of v, and sets s to scanned. To relax a particular arc from v to some other vertex w, the d value for the vertex w is compared to the sum of the d value for v and the actual length of the arc from v to w. If the d value for w is greater than the sum, then the d value for w is set to the sum, the p value for w is set to v, and the s value is set to labeled. Dijkstra's implementation of the labeling method at each step selects the labeled vertex with the smallest label to scan next. The algorithm finishes with the correct shortest path distances, as well as a shortest path tree Tₛ induced by the parent pointers.

For the purposes of finding the shortest path between s and t, the method described above can be stopped when the vertex t is about to be scanned and the resulting shortest path reconstructed by following the parent pointers from t. Then the path from s to t defined by the parent pointers is the shortest path from s to t. The method can be improved by simultaneously performing Dijkstra's algorithm on the forward and reverse of the graph. The algorithm can then stop when either the forward or backwards algorithm selects a vertex that the other has already scanned.

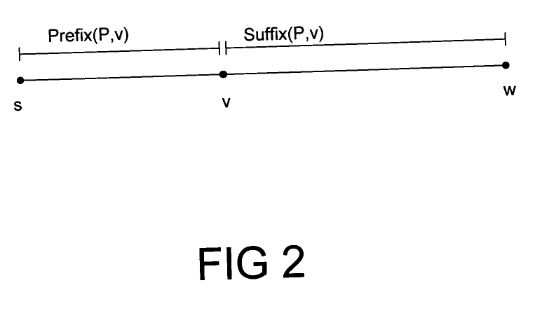

The concept of vertex reach can be used to further improve Dijkstra's search described above. As illustrated in FIG. 2, given a path P from s to t and vertex v on the path P, the reach of the vertex v , r(v), with respect to the path P is the minimum of the length of the prefix of P (i.e., the subpath from s to v), and the length of the suffix of P (i.e., the subpath from v to t). The reach of v, r(v), is the maximum, over all of the shortest paths P through v, of the reach of v with respect to P. The prefix of P and the suffix of P with respect to v are illustrated on FIG. 2 as prefix(P,v) and suffix(P,v) respectively.

A simple way to compute the exact reaches of vertices is to compute all of the shortest paths as described above and apply the definition of vertex reach to the vertices. However, this method is impractical for very large graphs. A more efficient method is to compute an upper bound on the reach of every vertex. The upper bound of the reach on a particular vertex v can be represented by r̅ (v). In addition, dist(v, w) can represent the lower bound on the distance from v to w. If r̅ (v) is less than dist(s, v) and r̅ (v) is less than dist(v, t), then v is not on the shortest path from s to t, and therefore Dijkstra's algorithm may skip the vertex v. Thus, vertices can be pruned from the search space using upper bounds on reaches.

As described above, exact reaches can be easily computed from the shortest paths. However, a better algorithm featuring shortest path trees can also be used. For example, a variable representing the reach of each vertex, r(v), can be established. Its initial value is set to zero, for example. For each vertex x a shortest path tree Tₓ may be computed. For each vertex v, its reach r(v) with respect to x within the tree is determined, given by its depth (i.e, the distance to the root), and its height (i.e., the distance to its farthest descendant). If the calculated r(v) with respect to x is greater than the r(v) stored in the variable, then the variable is desirably updated to the calculated r(v).

As described previously, to prune Dijkstra's search based on r(v), the lower bounds on the distance from s (i.e., the source) to v and from v to t (i.e., the sink) are desirably calculated. However, lower bounds implicit in the search can also be used to prune the vertex. During the forward direction of the bidirectional Dijkstra's search, a variable Γ can be used to represent the smallest distance label of a vertex found in the reverse direction of the search. Therefore, if a particular vertex v has not been scanned in the reverse direction, then Γ represents the lower bound of the distance label from v to the destination t. When v is about to be scanned, then it can be assumed that d_{f}(v) is the distance from the source s to v. Therefore, the search can be pruned at v if v has not been scanned in the reverse direction, r̅ (v) is less than d_{f}(v), and r̅ (v) is less than Γ. Similarly, this applies in the reverse direction. This algorithm is the bidirectional bound algorithm.

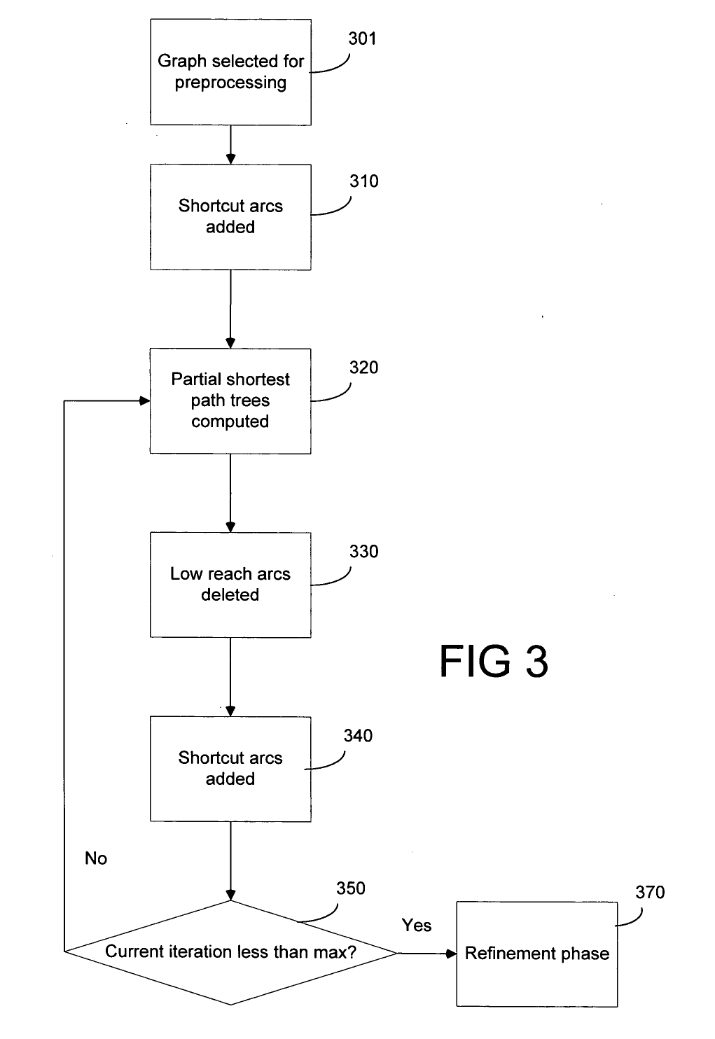

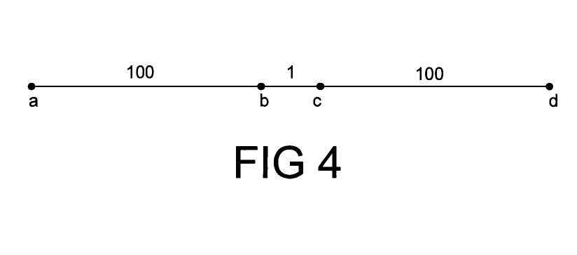

FIG. 3 illustrates an iterative algorithm for graph preprocessing. Preprocessing the graph desirably removes low-reach arcs to improve the performance of a later query phase. At 301, a graph is selected for processing. The graph comprises a plurality of vertices and arcs. At 310, shortcut arcs are desirably added to the graph to reduce the reach of some arcs and eliminate bypassable vertices. Shortcuts arcs, and their generation, are described in further detail with respect to FIG. 4.

At 320, partial shortest path trees are computed for each of the vertices in the graph and the arcs in the graph are divided into a group with small reaches and a group with large reaches. Whether or not a particular arc is considered to be a high or low reach arc is determined by comparing it to a reach threshold. The reach threshold is desirably a function of the current iteration of the preprocessing algorithm, for example.

At 330, low-reach arcs are desirably removed from the graph. In addition, penalties are added to the graph to replace the deleted arcs. The addition of penalties is necessary to account for deleted arcs in later iterations of the preprocessing algorithm. The addition of penalties is described in more detail below.

At 340, additional shortcuts are added to the current graph. Shortcuts are desirably added to reduce the reach of certain arcs in the graph, thus allowing the graph to shrink faster during preprocessing.

At 350, it is determined if the current iteration of the preprocessing algorithm is the last iteration. The preprocessing algorithm continues iteratively until there are no arcs remaining in the graph. If there are no further iterations to execute (i.e., no remaining arcs), then the algorithm continues at 370 for an optional refinement phase. Else, the current iteration is incremented and the algorithm desirably continues at 320.

At 370, the calculated upper bounds on the reaches of the vertices are desirably recalculated during an optional refinement phase. However, because the iterative portion of the algorithm calculated arc reaches, rather than vertex reaches, the calculated upper bounds on arc reaches are desirably first converted to the bounds on vertex reaches. Conversion of arc reaches to vertex reaches is discussed in more detail below. The number of vertices selected for upper bound reach recalculation is a trade off between the time spend recalculating and the improvement gained.

In order to better understand the preprocessing algorithm the concept of shortcut arcs is discussed below. Consider the graph illustrated in FIG. 4. The length of segments ab, l(a,b), and cd, l(c,d), are 100, while the length of segment bc is 1. Based on the above definition of reach, r(a) and r(d) are both 0, while r(b) and r(c) are 100.

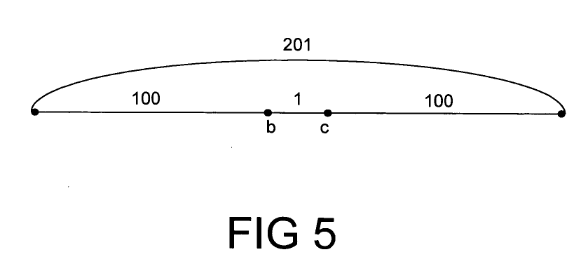

FIG. 5 illustrates a similar graph as FIG. 4, only a new segment ad is added with l(a,d)=201. None of the reaches of the vertices in FIGS. 4 and 5 are affected by the addition of the new arc. Thus, r(a) and r(d) remain 0, while the r(b) and r(c) remain 100. However, if the new arc is made preferable, the r(b) and r(c) are reduced from 100 to 1.

Given a path P from v to w, a segment or arc(v,w) is a shortcut arc for the path P if the length of the arc is equal to the length of the path P. However, for use in an approximate reach algorithm, such as the partial tree algorithm described above, the concept of a canonical path is necessary. The canonical path is a shortest path with the following additional properties:
1. A canonical path is a simple shortest path.
2. For every source s, and sink t, there is a unique canonical path between s and t.
3. A sub path of a canonical path is a canonical path.
4. Dijkstra's algorithm can find canonical shortest paths.
5. A path Q is not a canonical path if Q contains a sub path P with more than one arc such that the graph contains a shortcut arc for P.
6. For any pair of shortcut paths, either they do not intersect, or one is contained in the other.

Property 5 is necessary to ensure that adding shortcut arcs decreases vertex reaches. Property 6 bounds the number of shortcuts by n, the number of vertices.

Canonical paths are implemented by generating a length perturbation, l′(a). While computing the length of a path, lengths and perturbations are separately summed along the path. The perturbations can then be used to break ties in path lengths. Assuming there are no shortcut arcs, if the perturbations are chosen uniformly at random from a large enough range of integers, there is a high probability that all shortest paths will be canonical paths. Shortcut arcs can be added after the perturbations are introduced. The length and the perturbation of a shortcut arc are equal to the sum of the corresponding values for the arcs of the path that is having the shortcuts added. In order to break ties in a graph with shortcuts, the number of hops can be used along with the perturbations. Because of property 6, there can be no ties remaining after breaking ties by perturbations and hops even when shortcuts have been introduced.

The preprocessing algorithm computes upper bounds on reaches with respect to the set of canonical paths as defined above using tie breaking by perturbations and hops. These reaches are then used to prune vertices from the graph during a query.

As described previously, partial trees may be used to compute upper bounds of vertex reaches. In order to understand the concept of partial trees, consider a graph such that all shortest paths are unique and therefore canonical, and a parameter ε. Vertices in the graph can be partitioned into two groups. A first group with reaches greater than ε, and a second group with reaches at most ε. For each vertex x in the graph, Dijkstra's shortest path algorithm is run with an early termination condition. Let T be the current shortest path tree maintained by the algorithm and T′ be a subtree of T induced by the scanned vertices. Any path in T′ is necessarily a shortest path. The tree construction stops when, for every leaf y of T′, one of the following two conditions is true:
1. y is a leaf of T; or
2. if x′ is the vertex adjacent to x of the x-y path in T′, then the length of the x′-y path in T′ is at least 2ε.
   Let Tₓ represent T′ when the tree construction stops. The algorithm marks all vertices that have reach of at least ε with respect to a path in Tₓ as high-reach vertices.

The partial tree algorithm runs in iterations, with the value of ε being multiplied by a constant α for each new iteration. Arc reaches, which are described below, are used instead of vertex reaches, and shortcuts are added at each iteration. During each subsequent iteration the algorithm runs the partial tree step on the resulting subgraph comprising arcs whose reach has been determined to be larger than αε, and penalties incorporated from arcs deleted in previous iterations.

The concept of arc reach is similar to vertex reach as described above. Given a path P from s to t and an arc(v,w) on P, the reach of the arc(v,w) with respect to P is the minimum of the length of the prefix of P from s to w, and the suffix of P from v to t. Similarly, pruning based on arc reaches is similar to pruning based on vertex reaches. While it can be shown that arc reaches are more effective than vertex reaches for reach pruning, they are also more expensive to store. Generally, the number of arcs in a graph is larger than the number of vertices. In addition, because each arc appears in both the forward and reverse graph, either the reach value is duplicated, or some type of stored identifiers must be assigned to the arcs to avoid the duplication. Therefore, arc reaches are desirably used during the offline preprocessing phase, while vertex reaches may be used during the query stage, for example.

Arc reaches can be converted into vertex reaches. To facilitate this, the upper bounds for the arc reaches are converted into upper bounds on vertex reaches. For example, consider a vertex v, an arc (v,w) and a path p that determines r(v). In addition, the arc(u,v) and the arc(v,w) are the arcs entering and leaving v on p. The reach of each of these arcs for p must be at least the reach of v, r(v). However, it is not known which of the neighbors of v are the vertices that determine this reach. Fortunately, a bound for the reach of v is the minimum of the highest incoming arc reach (i.e, the reach of the arc from some vertex x to v) and the highest outgoing arc reach (i.e., the reach of the arc from vertex v to some vertex y).

The bound can be improved when the two maximums are achieved for x and y being the same vertex. First, let x′ be the vertex for which the maximum over x of r(x,v) is achieved, let y′ be the vertex for which the maximum over all y different from x′ of r(v,y) is achieved, and let d′ be the minimum of r(x′,v) and r(v,y′). Second, let y″ be the vertex for which the maximum over y of r(v,y) is achieved, let x″ be the vertex for which the maximum over all x different from y″ of r(x,v) is achieved, and let d″ be the minimum of r(x″,v) and r(v,y″). Set the bound on r(v) to the maximum of d′ and d″.

Similarly to vertex reaches, partial trees can be used to find arcs whose reaches are greater than a certain threshold. For a particular graph G, a variable is initialized at zero, for each arc in the graph. Partial trees are then grown for each vertex in G. The reach of the arcs within each partial tree is measured, and where the reach is greater than the reach recorded in the associated variable, the variable is updated with the new reach. The stored reach value for each arc will be the maximum reach observed within all the relevant partial trees.

Note that long arcs can pose an efficiency problem for the partial tree approach. If x has an arc with length 100ε adjacent to it, the depth of Tₓ is at least 102ε. Therefore building Tₓ will be expensive. This can be dealt with by building smaller trees in such cases, as described below. This increases the speed of the algorithm at the expense of classifying some low-reach vertices as having high reach.

Consider a partial shortest path tree Tₓ rooted at a vertex x and let v be a vertex of Tₓ different from x. Let f(v) be the vertex adjacent to x on the shortest path from x to v. The inner circle of Tₓ is the set containing the root x and vertices v with the property that d(v)−l(x, f(v)) is less than or equal to a threshold ε. Vertices in the inner circle are known as inner vertices, while all other vertices are known as outer vertices. The distance between an outer vertex w and the inner circle is defined as the length of the path between w and the closest inner vertex. The partial tree continues to grow until all labeled vertices are outer vertices and have a distance to the inner circle greater than ε.

Once the partial tree is built, the reach can be computed for all arcs originating from the inner circle. The depth of v, depth(v), is defined as the distance from the root x to v within the tree. The height of v, height(v), is defined as the distance from v to its farthest scanned descendant, as long as no descendant is labeled. If there is at least one labeled descendent, then height(x) is infinity. The reach of an arc(u,v) with respect to the tree Tₓ is defined as r((u,v), Tₓ) and equal to the minimum of the depth(v) and the sum of the height(v) and the length of the arc. For each inner arc, the calculated reach within the tree is compared with the current estimate, and if it is greater, the estimate is updated.

After all partial trees are grown, every reach estimate with a value at most ε is valid. Arcs with reach estimates less than ε can then be eliminated from the graph. The remaining arcs in the graph all have reach estimates greater than ε.

In order to compute valid reach upper bounds for arcs like these, the partial tree algorithm can be modified to take into account the deleted arcs using penalties. For a subgraph of graph G at iteration i, Gᵢ, the in-penalty associated with a particular vertex v is defined as the maximum r̅ (u,v) for all arcs(u,v) that have been removed from the graph in a previous iteration. Similarly, the out-penalty for a v in Gᵢ is s defined as the maximum r̅ (v,w) for all arcs (v,w) that have been removed from the graph in a previous iteration.

Given the partial tree algorithm described above, penalties can be incorporated by redefining depth and height as follows. Given a partial tree Tₓ rooted at a vertex x , depth(v)=d(v)+in-penalty(x), where d(v) is the distance from x to v in the tree.

In order to redefine height, the concept of pseudo-leaves is introduced. Given a partial tree, for each vertex v in the tree, a new child v′ (i.e, the pseudo-leaf) is desirably created along with an arc (v, v′) with a length equal to the out-penalty(v). The pseudo-leaf serves as a representative of original arcs not present in the current subgraph. The height of a vertex v is defined as the distance between v and the farthest pseudo-leaf.

As discussed previously with respect to FIG. 3, the preprocessing algorithm may introduce shortcuts to the graph to eliminate certain vertices. These vertices may be known as bypassable vertices. A vertex v can be described as bypassable if one of two conditions holds. It has exactly one incoming arc, and one outgoing arc. Or, alternatively, it has exactly two outgoing arcs, (v,u) and (v,w), and exactly two incoming arcs, (u,v) and (w,v), wherein the outgoing and incoming arcs are reversals of one another. Shortcuts can be added to the graph to go around such bypassable vertices.

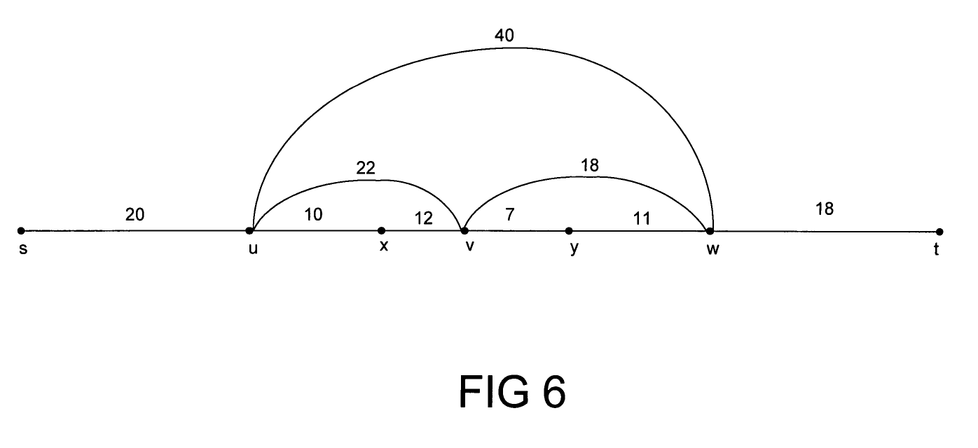

A line can be defined as a path in the graph containing at least three vertices, where all vertices except for the first and the last are bypassable. Every bypassable vertex belongs to exactly one line. Once a line is identified, the line may be bypassed by adding a shortcut. The shortcut may be added in a single step, where if the first line vertex is u and the last is w, a shortcut may be added between u and w. However, if there are several arcs within the line, and better approach may be to further add more shortcuts, as illustrated in FIG. 6.

FIG. 6 is an illustration of how adding shortcuts to a graph can reduce vertex reach. As shown the graph comprises vertices s, u, x, v, y, w, and t. The reach of s is 0, the reach of u is 20, the reach of x is 30, the reach of v is 36, the reach of y is 29, the reach of w is 18, and the reach of t is 0. If a shortcut is added between u and w, the subsequent reaches of three vertices are reduced. The reach of x is reduced to 19, the reach of v is reduced to 12, and the reach of y is reduced to 19. If an additional shortcut is added to the graph from u to w and v to w, the reaches of x and y can be further reduced to 0.

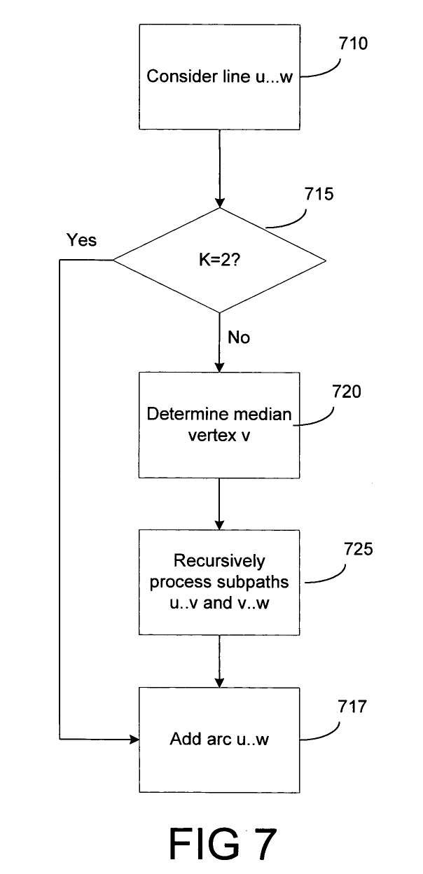

FIG. 7 illustrates a method for adding shortcut arcs to a graph. At 710, a candidate line beginning with vertex u and ending with vertex w is identified having k arcs (where k is greater than or equal to 2). At 715, if k is equal to 2, then there is only one internal vertex and a shortcut may be added between u and w at 717, and the process may exit. Else, k is greater than 2, and the process may proceed to 720. At 720, the vertex v closest to the median of the line is identified. At 725, sub paths within the line are recursively processed adding at least shortcuts u to v and v to w to the graph. After recursively processing the sub paths, the process may add the shortcut between u and w and exit at 717.

The above described algorithm may be further improved to avoid long shortcuts. As shown there may be lines with many arcs. These arcs may cause the partial trees algorithm to be less effective in later iterations. To avoid this a maximum arc length may be predetermined. The maximum arc length may be a function of the current iteration of the preprocessing algorithm. For example, consider the line beginning with u and ending with w having k segments. If k is equal to 2 then a shortcut is created only if the length of the line is smaller than the threshold. Else, nothing is done. If k is greater than 3, the recursive calls are made regardless of the line length. However, the final shortcut is only added to the graph if its length is less than the threshold.

As described previously with respect to FIG. 3, the preprocessing algorithm desirably comprises an optional refinement phase to correct for increasing penalties. As discussed above, penalties are introduced to the graph to compute valid upper bounds where vertices have been deleted. However, as the algorithm progresses these bounds become less tight because the penalties increase. As a consequence, the additive errors may become larger for vertices that remain in the graph after several iterations.

To better correct for the additive errors, a refinement step may be included in the preprocessing algorithm. After finding the upper bounds using the partial trees, the refinement step desirably re-computes the reaches of a predetermined number of the vertices with the highest reach upper bounds. The subgraph comprising the set of high reach vertices and associated arcs is selected from the graph. The number of vertices selected is determined by the desired time for the refinement phase. For example, a run time of approximately 30% of the main preprocessing phase may be appropriate. This subgraph has desirably been through several iterations of the shortcut step, and desirably comprises original arcs, as well as additional shortcut arcs added during the shortcut step.

After selecting the subgraph comprising the high reach vertices, an exact reach computation may be performed on the vertices in the subgraph. The exact reaches may be computed by growing complete shortest path trees. Because these shortest path trees are only run from each vertex in the subgraph, the in and out-penalties for the additional vertices in the graph should also be considered.

The reach-based graph pruning described above can be combined with A* search. The A* search operates to find shortest paths similarly to Dijkstra's method but for each step a labled vertex v with the smallest key is selected to scan next. The key may be defined as k_{f}(v)=d_{f}(v)+π_{f}(v), where π_{f} is a potential function that gives an estimate of the distance from v to the sink t. The potentials can be found, for example, by using triangle inequality in combination with recomputed distances to a set of landmark vertices.

During the A* search, when a vertex v is about to be scanned, the length of the shortest path from the source s to v is extracted from the key of v. If the calculated reach of v is smaller than both d_{f}(v) and π_{f}(v), the search can be pruned at v.

Exemplary Computing Environment

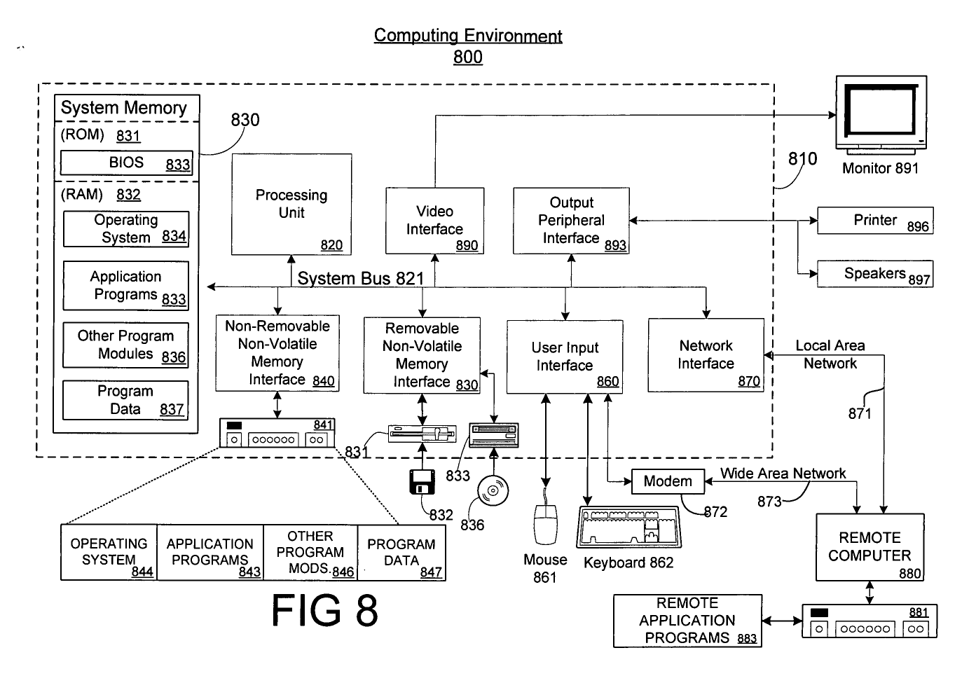

FIG. 8 illustrates an example of a suitable computing system environment 900 in which the invention may be implemented. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing the invention includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 810 typically includes a variety of computer readable media. Computer readable media can be any available media that can be accessed by computer 810 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or non-volatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/non-volatile computer storage media. By way of example only, FIG. 8 illustrates a hard disk drive 840 that reads from or writes to non-removable, non-volatile magnetic media, a magnetic disk drive 851 that reads from or writes to a removable, non-volatile magnetic disk 852, and an optical disk drive 855 that reads from or writes to a removable, non-volatile optical disk 856, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted include a LAN 871 and a WAN 873, but may also include other networks. Such networking environments are commonplace in offices, enterprise-wide computer networks, intranets and the internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 883 as residing on memory device 881. It will be appreciated that the network connections shown are exemplary and other means of establishing a communications link between the computers may be used.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for graph preprocessing comprising:
receiving a graph, the graph comprising a plurality of vertices and arcs;
generating shortcut arcs; and
computing arc reach bounds.

2. The method of claim 1, wherein computing arc reach bounds comprises:
dividing the arcs into a set of low reach arcs and a set of high reach arcs; and
removing the set of low reach arcs from the graph.

3. The method of claim 2, wherein removing the set of low reach arcs from the graph comprises removing the set of low reach arcs and replacing them with penalties.

4. The method of claim 1, further comprising:
converting arc reach bounds into vertex reach bounds;
selecting a subset of the vertices using the vertex reach bounds; and
recalculating the vertex reach bounds for the selected subset of the vertices.

5. The method of claim 4, wherein the subset of vertices comprises the vertices with the highest vertex reach bounds.

6. The method of claim 4, further comprising:
receiving a query comprising a first vertex and second vertex, wherein the first and second vertex are located in the graph; and
calculating the shortest path between the first and second vertex in the graph using the vertex reach bounds.

7. The method of claim 1, wherein the graph comprises a map.

8. The method of claim 1, wherein generating a shortcut arcs comprises:
identifying a bypassable vertex between a first vertex and a second vertex; and
generating an arc between the first and second vertex.

9. The method of claim 8, further comprising removing the bypassable vertex from the graph.

10. A system for determining the shortest path between two vertices in a graph comprising:
an input device adapted to receive a source vertex and a destination vertex from a graph, wherein the graph comprises a plurality of arcs and vertices;
a storage device adapted to store preprocessing data, wherein the preprocessing data comprises vertex reach bounds and the graph with the addition of shortcut arcs; and
a processor adapted to compute the shortest path in the graph between the source vertex and the destination vertex using the preprocessing data.

11. The system of claim 10, wherein the processor is further adapted to generate the preprocessing data by:
generating shortcut arcs;
computing arc reach bounds; and
converting arc reach bounds to vertex reach bounds.

12. The system of claim 11, wherein the processor generating the preprocessing data further comprises:
selecting a subset of the vertices using the vertex reach bounds; and
recalculating the vertex reach bounds for the selected subset of the vertices.

13. The system of claim 1 1, wherein the processor generating shortcut arcs comprises:
identifying a bypassable vertex between a first vertex and a second vertex; and
generating an arc between the first and second vertex.

14. The system of claim 10, wherein the graph is a map.

15. A computer-readable medium with computer-executable instructions stored thereon for performing the method of:
receiving a graph, the graph comprising a plurality of vertices and arcs;
generating shortcut arcs; and
computing arc reach bounds.

16. The computer-readable medium of claim 15, wherein computing arc reach bounds comprises computer-executable instructions for:
dividing the arcs into a set of low reach arcs and a set of high reach arcs; and
removing the set of low reach arcs from the graph.

17. The computer-readable medium of claim 15, further comprising computer-executable instructions for:
converting arc reach bounds into vertex reach bounds;
selecting a subset of the vertices using the vertex reach bounds; and
recalculating the vertex reach bounds for the selected subset of the vertices.

18. The computer-readable medium of claim 17, further comprising computer-executable instructions for:
receiving a query comprising a first vertex and second vertex, wherein the first and second vertex are located in the graph; and
calculating the shortest path between the first and second vertex in the graph using the vertex reach bounds.

19. The computer-readable medium of claim 15, wherein generating shortcut arcs comprises computer-executable instructions for:
identifying a bypassable vertex between a first vertex and a second vertex; and
generating an arc between the first and second vertex.

20. The computer-readable medium of claim 19, further comprising computer-executable instructions for removing the bypassable vertex from the graph.
